(19) United States
(12) Patent Application Publication
(10) Pub. No.: US 2010/0063172 A1
(43) Pub. Date: Mar. 11, 2010

(54) SYSTEM AND METHOD FOR MANUFACTURING MOLDED STRUCTURES USING A HIGH DENSITY MATRIX OF MICROPARTICLES

(75) Inventor: Hans Negle, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/440,052

(22) PCT Filed: Aug. 30, 2007
(86) PCT No.: PCT/IB07/53499

§ 371 Date: Nov. 20, 2009

(30) Foreign Application Priority Data
Sep. 8, 2006 (EP) 06120356.8

(51) Int. Cl. C08G 77/04; B28B 1/20; C08F 2/04

(52) U.S. Cl. 521/142; 264/104; 425/435; 521/154

(57) ABSTRACT

A method for manufacturing a molded structure includes the provisioning of a first mixture which includes microparticles and a liquid-phase mixture of resin and curing agent. The first mixture is centrifuged to extract a volume of the liquid-phase resin and curing agent mixture from the first mixture, the centrifuging process resulting in the formation of a liquid-phase matrix of microparticles which are at least partially-coated with liquid-phase resin and curing agent. The liquid-phase matrix of at least partially coated microparticles is cured to form a solid-phase matrix of microparticles, thereby providing the molded structure.

### FIELD OF INVENTION

The present invention relates to systems and methods for manufacturing molded structures, and more particularly, to systems and methods for manufacturing molded structures by means of a high density matrix of microparticles.

### BACKGROUND OF THE INVENTION

Molded structures find utility in many applications. For example, in the technical area of x-ray generation, the production of molded, high voltage insulating structures for use in x-ray generators is urgently needed. In particular, x-ray computed tomography (CT) generators travel at high rotational speeds which subject their internal parts to high gravitational forces. The high gravitational forces increases the weight loading of the x-ray generators on the x-ray scanning system, requiring additional structural modifications and reinforcements to be made to the scanning system which are expensive to provide and maintain. Weight reduction is of the utmost interest in this regard. Similar challenges are also faced in the aircraft/spacecraft/airborne, automobile, and other industries which employ components requiring mechanically strong, light weight insulating materials.

European Patent Application 1614124 “Method for Producing Molded Parts for Low-Voltage, Medium Voltage and High-Voltage Switchgear” illustrates a conventional approach to reduce the weight of such structures exposed to high gravitational forces. In such an approach microspheres of varying diameters or “grades” are immersed into a resin and curing agent mixture, compacted to the desired level of density, and subsequently cure the resulting mixture to form the desired shape. The resin and curing agent mixture can be selected to provide high voltage isolation, and the hollow microspheres provide a significant reduction in weight compared to a solid structure.

However, disadvantages accompany the described manufacturing technique. If too little of the resin/curing agent mixture is used (or too many microspheres added), there is an insufficient amount of the resin/curing agent mixture to sufficient coat the outer surfaces of the microspheres. As a result the matrix is weakened and the molded structure becomes structurally unsound. In the instance in which the molded structure is intended to provide high voltage insulation, an insufficient amount of resin/curing agent mixture can reduce the breakdown voltage of the molded structure, resulting in a lower voltage rating. Alternatively, if too much of the resin/curing agent mixture is used, the highest possible density of microparticles in the molded structure is not achieved. Even if the correct ratio of microspheres to resin/curing agent mixture is used, microspheres are distributed throughout the resin/curing agent mixture in a non-uniform manner, resulting in some areas having an insufficient amount of resin/curing agent, and some areas having an excessive amount, resulting in the aforementioned drawbacks.

### SUMMARY OF THE INVENTION

Accordingly, an object of the present invention is to provide an improved system and method for manufacturing molded structures having a high density matrix of microparticles.

This need may be met by a system and method for manufacturing according to the independent claims.

In one embodiment of the invention, a method for a manufacturing a molded structure is presented and includes provisioning a first mixture that includes microparticles and a liquid-phase mixture of resin and curing agent. The first mixture is centrifuged to extract a volume of the liquid-phase resin and curing agent mixture from the first mixture, the centrifuging process resulting in the formation of a liquid-phase matrix of microparticles which are at least partially-coated with liquid-phase resin and curing agent. The liquid-phase matrix of at least partially coated microparticles is cured to form a solid-phase matrix of microparticles, thereby providing the molded structure.

In such a manner, a solid-phase matrix of microparticles can be formed at extremely high densities to provide various properties, such as low weight, high voltage insulation, high magnetic field strength, and other properties.

In another embodiment of the invention, a system adapted for manufacturing a molded structure is presented and includes a centrifuge operable to spin around a spin axis, and a casting mold mechanically coupled to the centrifuge. The casting mold is adapted to contain a first mixture of microparticles and a liquid-phase mixture of resin and curing agent, the casting mold further including one or more outlet ports through which a volume of the liquid-phase resin and curing agent from the first mixture is evacuated when the casting mold is spun. Particularly, the casting mold is operable to retain a liquid-phase matrix of microparticles which are at least partially-coated with the liquid-phase resin and curing agent mixture when the centrifuge is spun. The retained liquid-phase matrix includes a high density of microparticles, which when cured, exhibits extremely high microparticle density. Such high density structures can provide enhancements based upon the characteristics of the microparticles, for example, light weight when hollow microspheres are used, or a high magnetic field strength when ferro-magnetic microparticles are employed.

Accordingly, it may be seen as a gist of an exemplary embodiment of the present invention that centrifugal forces are used to separate microparticles from the liquid-phase resin and curing agent mixture in which the microparticles are immersed, the microparticles retaining a surface coating of the resin and curing agent mixture, which, when cured, provides an solid-phase matrix of the microparticle to form the molded part. In this manner, an excess of resin and curing agent mixture in the construction of the molded structure is avoided, and a high filling grade of the molded structure is achieved.

It will be apparent that the physical and electrical properties of the molded structure will take on those characteristics provided by the microparticles and resin/curing agent components. For example, when a low weight molded structure is sought, light weight microparticles, e.g., hollow or gas-filled microspheres may be used. In another embodiment in which a concentrated magnetic field is sought, the microparticles may be ferro-magnetic material, such as iron powder and the like. Furthermore, the molded structure itself may be either rigid or flexible in form. For example, an epoxy resin/curing agent mixture which hardens to a rigid form may be employed to provide a pre-form, load-bearing structure. Alternatively, a flexible structure may be formed by implementing silicon, polyethylene, or other elastimer-based resin/curing agent mixture to provide a bendable, conformable structure.

The following describes exemplary features and refinements of a method for manufacturing the molded structure in accordance with the invention, although these features and refinements will apply to the manufacturing system as well.

In one embodiment of the manufacturing method, the microparticles are conductive/inductive microbeads which exhibit a higher (i.e. heavier) specific weight compared to the specific weight of the liquid-phase resin and curing agent mixture. The conductive/inductive microbeads and the liquid-phase resin and curing agent mixture are supplied to a casting mold, the casting mold having one or more outlet ports. Upon centrifuging the casting mold, a volume of the lower specific weight liquid-phase resin and curing agent mixture is extracted via the one or more outlet ports, leaving a liquid-phase matrix of at least partially-coated conductive/inductive microbeads within the casting mold. The liquid matrix is then cured to form a molded structure of conductive/inductive microbeads. Such an embodiment may be used to form a dense matrix of ferromagnetic microparticles (e.g. iron powder) either in a rigid (e.g. epoxy resin) or flexible (silicon) matrix. The one or more outlet ports may be positioned either proximate to the spin axis, distal to the spin axis, or in both locations in which at least one outlet port is located proximate to the spin axis and at least one outlet port is positioned distal to the spin axis.

In another embodiment of the manufacturing method, the microparticles are insulating microbeads which exhibit a higher (i.e., heavier) specific weight compared to the specific weight of the liquid-phase resin and curing agent mixture. The insulating microbeads and the liquid-phase resin and curing agent mixture are supplied to a casting mold, the casting mold having one or more outlet ports. Upon centrifuging the casting mold, a volume of the lower specific weight liquid-phase resin and curing agent mixture is extracted via the one or more outlet ports, leaving a liquid-phase matrix of at least partially-coated insulating microbeads within the casting mold. The liquid matrix is then cured to form a molded structure of insulating microbeads. Such an embodiment may be used, e.g., to form a densely-packed structure having a very high breakdown voltage. The one or more outlet ports may be positioned either proximate to the spin axis, distal to the spin axis, or in both locations, in which at least one outlet port is located proximate to the spin axis and at least one outlet port is positioned distal to the spin axis.

In still a further embodiment of the manufacturing method, the microparticles are insulating microspheres which exhibit a lower (i.e., lighter) specific weight compared to the specific weight of the liquid-phase resin and curing agent mixture. The insulating microspheres and the liquid-phase resin and curing agent mixture are supplied to a casting mold, the casting mold having one or more outlet ports. Upon centrifuging the casting mold, a volume of the higher specific weight liquid-phase resin and curing agent mixture is extracted via the one or more outlet ports, leaving a liquid-phase matrix of at least partially-coated insulating microspheres within the casting mold. The liquid matrix is then cured to form a molded structure of insulating microspheres. Such an embodiment may be used, for example, to form a light weight structure having a high voltage breakdown. The one or more outlet ports may be positioned either proximate to the spin axis, distal to the spin axis, or in both locations in which at least one outlet port is located proximate to the spin axis and at least one outlet port is positioned distal to the spin axis.

Optionally, the manufacturing method includes agitating the first mixture of the microparticles and liquid-phase resin and curing agent to facilitate extraction of a volume of the liquid-phase resin and curing agent mixture. Such a feature can facilitate achieving a high filing grade and higher microparticle density within the formed liquid matrix. Further optionally, the manufacturing method may include removing the casting mold containing the liquid-phase matrix of the at least partially-coated microparticles from the centrifuge, and curing the liquid-phase matrix in an oven to form the solid-phase matrix of microparticles. Still further optionally, the casting mold further includes one or more heating elements disposed around at least a portion of the periphery of the casting mold, and the curing process includes applying a predetermined heating profile to the casting mold via the one or more heating elements. Such a feature allows continued supply of microparticles and resin and curing agent mixture to the casting mold during curing to compensate for volume shrinkage and to eliminate voids in the matrix.

The following describes exemplary features and refinements of the system for manufacturing the molded structure in accordance with the invention, although these features and refinements may also apply to the aforementioned manufacturing method.

In one embodiment of the manufacturing system, a centrifuge which emulates the size and connection points of an x-ray scanning system gantry is employed to spin one or more casting molds. Such a system could be used to manufacturing multiple molds concurrently. Further exemplary, one or more outlet ports are formed on the casting mold, the outlet port including a barrier (e.g., a screen, grating, mesh, or a small gap etc.) operable to retain microparticles (e.g., microspheres) larger than a predefined size (e.g., 10 um) within the casting mold.

The liquid-phase matrix may be cured into a solid-phase matrix either at ambient temperature or an elevated temperature. When an elevated temperature is needed, the manufacturing system may include an oven adapted to receive and elevate the temperature of the casting mold to the required temperature to cure the liquid-phase matrix disposed therein. Alternatively, the manufacturing system may include one or more heating elements disposed around the periphery and/or inside the casting mold. Further optionally, two or more heating elements may be employed to provide a particular heating profile to the casting mold for curing the liquid-phase matrix contained therein such that peripheral areas most distal to the intake port are cured first, and areas more proximate to the intake are cured subsequently. With such a curing profile, the intake of the casting mold remains free so as to supply additional resin/curing agent and microparticle mixture, thereby preventing the formation of voids within the cured structure, as well as to compensate the volume shrinkage.

In another exemplary embodiment, the casting mold includes an intake port configured to receive a mixture of the resin/curing agent and/or microparticles, and the manufacturing system includes a reservoir in communication with the casting mold via the intake port, the reservoir operable to contain a phase mixture of resin/curing agent and/or microparticles for supply to the casting mold. Supply of additional resin/curing agent and/or microparticles to the casting mold assists in compensating volume shrinkage and preventing the formation of voids in the matrix. The manufacturing system may further include a relief kidney which is in communication with the casting mold via the outlet port, the relief kidney operable to receive a volume of the liquid-phase mixture of resin and curing agent taken up from the casting mold.

The operations of the foregoing methods may be realized by a computer program, i.e. by software, or by using one or more special electronic optimization circuits, i.e. in hardware, or in hybrid/firmware form, i.e. by software components and hardware components. The computer program may be implemented as computer readable instruction code in any suitable programming language, such as, for example, JAVA, C++, and may be stored on a computer-readable medium (removable disk, volatile or non-volatile memory, embedded memory/processor, etc.), the instruction code operable to program a computer of other such programmable device to carry out the intended functions. The computer program may be available from a network, such as the WorldWideWeb, from which it may be downloaded.

These and other aspects of the present invention will become apparent from and elucidated with reference to the embodiment described hereinafter.

### DESCRIPTION OF THE DRAWINGS

An exemplary embodiment of the present invention will be described in the following, with reference to the following drawings.

FIG. 1 illustrates an exemplary method for manufacturing a molded structure in accordance with the present invention.

FIG. 2A illustrates a mixture of microparticles and a liquid-phase mixture of resin and curing agent in accordance with the present invention.

FIG. 2B illustrates an exemplary liquid-phase matrix of microparticles formed during the centrifuging process in accordance with the present invention.

FIG. 2C illustrates an exemplary liquid-phase matrix of microparticles formed upon completion of the centrifuging process in accordance with the present invention.

FIG. 3 illustrates a system for manufacturing a molded structure in accordance with one embodiment of the present invention.

FIG. 4 illustrates an exemplary casting mold in accordance with the present invention.

FIG. 5 illustrates a casting mold for manufacturing a high voltage insulation structure in accordance with the invention.

For clarity, previously-identified features retain their reference numerals in subsequent drawings.

### DESCRIPTION OF PREFERRED EMBODIMENTS

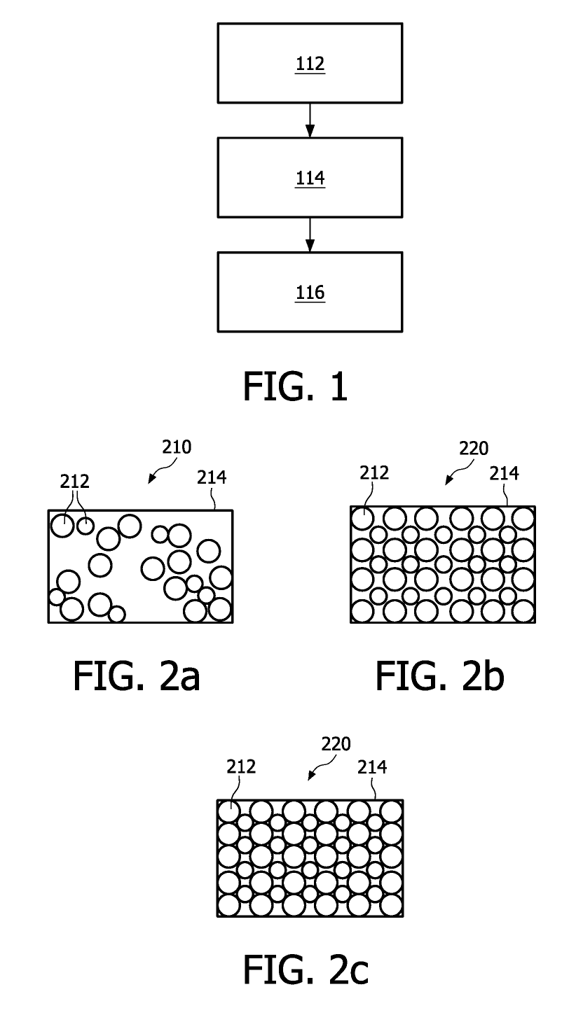

FIG. 1 illustrates an exemplary method for manufacturing a molded structure in accordance with the present invention. The method includes the provisioning of a first mixture that includes microparticles and a liquid-phase mixture of resin and curing agent (process 112).

A particular embodiment of process 112 is performed by providing the first mixture within a casting mold. The casing mold may be of varying sizes, and formed of different materials depending upon the application. An exemplary embodiment is shown in FIG. 5 and described below.

The first mixture is centrifuged to extract a volume of the liquid-phase resin and curing agent mixture from the first mixture (process 114). Centrifuging the first mixture results in the formation of a liquid-phase matrix of microparticles which are at least partially-coated with liquid-phase resin and curing agent mixture. In a particular embodiment, the centrifuging process 114 is continued until a filling grade of greater than 30 percent by volume or higher is achieved, a further specific embodiment being 40 percent or higher, and even further specific embodiments being greater than 50 percent, greater than 60 percent, greater than 70 percent, greater than 80 percent, and greater than 90 percent or higher by volume. The liquid-phase matrix is subsequently cured to form a solid-phase matrix of microparticles, thereby providing the molded structure in the desired shape (process 116).

FIG. 2A illustrates an exemplary first mixture provided in process 112 in accordance with the present invention. The first mixture 210 includes microparticles 212 immersed within a resin/curing agent mixture 214. The microparticles 212 are shown as a dual-grade mixture of microbeads/spheres, although other grades (single or multiple) and/or other geometries may be used in alternative embodiments under the invention. In general, the microparticles 212 are distributed randomly throughout the volume of the resin/curing agent mixture 214. When such an arrangement is cured, the microparticles 212 will be arranged in a highly dispersed and non-uniform manner, producing the aforementioned disadvantages of structural fragility and dispersed microparticle effects.

FIG. 2B illustrates an exemplary liquid-phase matrix of microparticles formed during the process 114 in accordance with the present invention. Upon centrifuging the first mixture to extract a volume of the liquid-phase resin and curing agent mixture 214, a liquid-phase matrix 220 is formed whereby the microparticles 212 immersed in the resin/curing agent mixture 214 are arranged in a more ordered and dense pattern.

FIG. 2C illustrates an exemplary liquid-phase matrix 220 of microparticles formed upon completion of process 114 in accordance with the present invention. As shown, a greater number of microparticles 212 are densely-packed within the volume, a majority of the microparticles retaining a thin layer of the resin/curing agent mixture 214 around its surface which contacts other coated microparticles 212. The total volume of extracted resin/curing agent mixture may be influenced by various factors, including the rotational speed of the centrifuge, the duration of centrifuging, i.e., the amount of time the centrifuge is spun, and/or the volume of the supply reservoir which supplies new resin/curing agent mixture, and/or the volume of the relief kidney which receives the extracted resin/curing agent mixture. When cured, the resulting solid-phase matrix will exhibit higher structurally strength and greater microparticle effects compared to a structure formed from the mixture 210 shown in FIG. 2A. FIG. 2C represents a dense packaging of microparticles using a bi-modal mixture (two different diameters) or microparticles, although a higher mixture modality may provide a higher packaging density in further embodiments of the present invention.

The microparticles 212 may be of a various shapes, sizes and material compositions, depending upon the intended function of the molded structure. For example, one possible implementation of the molded structure is its use as a magnet, or an iron core for an inductive element. In such an embodiment, the microparticles 212 (which are coated with a non-conductive layer in one embodiment) may be of iron or a magnetic (e.g., ferromagnetic) material which are densely collected within a particular volume to maximize the magnetic effect produced thereby. Examples include ferromagnetic microbeads having a diameter in the range of 10 um to 600 um, and more particularly from 20 um to 150 um. Other magnetic material of other sizes may be used as well. Those skilled in the art will appreciate that microparticles of other electrical or magnetic properties may be implemented in similar embodiment of the invention. Accordingly, the term “conductive/inductive microparticles” is used herein to denote microparticles exhibiting such electrical or magnetic properties, one such example being ferromagnetic microparticles described above. In still further embodiments, the microparticles 212 may be formed from other types of metals, for example lead, aluminum, magnesium, nickel, copper, silver, chromium, iron, gold, tungsten, other metallic elements as known from the periodic table, their alloys, and the like.

In another embodiment, the molded structure is intended for use as an electrically insulating molded structure. In such an embodiment, the microparticles 212 may be either solid microbeads or hollow microspheres (or a combination of both) which are arranged in a dense and uniform manner throughout the molded structure to provide an high voltage insulation between components. Exemplary materials for the microbeads and hollow microspheres include glass, plastic or other ceramic of synthetic materials exhibit a high electrical insulating effect. The solid microbeads and hollow microspheres may be formed in a generally circular shape having a diameter in the range of 5 um to 500 um, and more particularly from 10 um to 150 um. The hollow microspheres may be gas or air-filled, and have a wall thickness of less than 1 um (e.g., 0.2 um to 0.9 um). The solid core of the microbeads will allow for a higher breakdown voltage, while the hollow core of the microspheres provides the advantage of lower weight. Accordingly, either of the solid microbeads or hollow microspheres (or a combination of both) may be selected for use as electrically-insulating microparticles, depending upon the particular requirement needed. Additionally, the wall thickness of the hollow microspheres can be varied to adjust the balance between voltage isolation and strength on the one hand (thicker walls providing higher voltage isolation and greater strength) and weight (thinner walls providing lower weight) to provide the most optimum combination of voltage isolation and weight specifications for the molded structure. An exemplary embodiment of the glass microspheres is part no. 3MK20 available from 3M Corporation of Minnesota, USA.

Further particularly, microparticles of multiple grades (as illustrated in FIGS. 2A-2C) may be employed to realize the desired filling grade. As an example, in either of the aforementioned embodiment in which either hollow microspheres or ferromagnetic microparticles are employed, two or more grades (diameters) of the microparticles may be used, e.g., a first grade of microparticles <10 um in diameter, a second grade of microparticles in the range of 90-100 um, and a third grade of microparticles in the range of 300-400 um. Use of a multi-grade microparticle mixture aids in obtaining a high filling grade, as the smaller particles will migrate towards and occupy spaces between larger microparticles.

The microparticles may also be of various shapes, for example triangular/pyramidal, square, penta- or octagonal, irregular shaped, as well as spherical. The spherical shape provides an advantage in that adjacent microparticles are able to roll and glide over the entire surface areas. Such motion facilitates migration toward spaces between adjacent microparticles, as well as microparticle coating of the resin/curing agent mixture 214. Furthermore, the microparticle mixture may be substantially homogenous in shape, e.g., all spherically-shaped microparticles, or they may heterogeneous in shape, e.g., including spherically- as well as pyramidally-shaped microparticles.

As noted above, the resin and curing agent mixture 214 may be selected from a variety of materials which when cured provides the desired hardness, rigidity, flexibility, insulating, or other structural and electrical properties. In one exemplary embodiment in which a relatively rigid, low weight, and high voltage insulating molded structure is sought, hollow microspheres are used in combination with an epoxy resin/curing agent mixture 214 composed of, for example, resin and curing agents CY231 and HY925 available from Huntsman Corporation of Salt Lake City, Utah, USA. Further exemplary, a bonding/coupling agent may also be used to facilitate adhesion of the resin/curing agent mixture 214 to the surface of the microparticles 210. Exemplary bonding/coupling agents include part nos. S732 and BYK 9076 (BYK-Chemie GmbH, Wesel, Germany), in addition to a flexibilisator DY 044 (Huntsman Corp.) to complete the mixture.

In another embodiment, a relatively high magnetic molded structure, which can be rigid or flexible, is sought. In such an instance, ferromagnetic microparticles (e.g., iron powder) are used in combination with a rigid or elastimer resin/curing agent mixture 214, composed of, for example, silicone or polyethylene, provided, e.g., from thermoplastic pellets (Huntsman Corp.) or similar materials (e.g., part no. Sylgard 567, Dow Corning Corp.), in addition to the aforementioned in addition to a flexibilisator DY 044 (Huntsman Corp.) to complete the mixture. When a rigid structure is sought, the aforementioned resin/curing agents can be used.

The centrifuging process operates to separate constituents of a mixture based upon a difference in the specific weight of the mixture's constituents. In the present invention, the microparticles 212 selected may exhibit either a higher (i.e., heavier) or lower (i.e., lighter) specific weight compared to that of the resin and curing agent mixture 214, and accordingly the centrifuging process 114 (FIG. 1) will vary, depending upon the relative specific weights of the microparticles 212 to the resin/curing agent mixture 214.

In one embodiment of the invention, the microparticles 212 have a higher (i.e., heavier) specific weight than the resin/curing agent mixture 214. In such an embodiment, the process 114 of centrifuging the first mixture 210 to extract a volume of resin/curing agent mixture 214 is accomplished by extracting the lower specific weight resin/curing agent mixture 214 through one or more outlet ports of a casting mold holding the first mixture 210, the one or more outlet ports in one embodiment positioned proximate to the centrifuge spin axis. In this embodiment, the higher specific weight microparticles will be accelerated away from the centrifuge spin axis, displacing the resin/curing agent mixture toward the spin axis. In this manner, a volume of the resin/curing agent mixture 214 can be extracted from the first mixture 210, resulting in the liquid-phase matrix 220 within the casting mold. In another embodiment, the one or more outlet ports are positioned distal to the centrifuge spin axis, the outlet ports containing a screen, grate, or other obstruction operable to retain the microparticle of the smallest desired diameter therein. In such an embodiment, the speed of the centrifuge is used to expel the excess of the resin curing agent through the one or more distally located outlet ports, while the output ports' screen retains the microparticles within the casting mold. In still a further embodiment, the one or more outlet ports are positioned at both proximate and distal positions relative to the centrifuge spin axis, thereby providing possible resin/curing agent mixture extraction points on both the proximate or distal sides of the casting mold. Specific embodiments of the “heavy” microparticles include the aforementioned conductive/inductive microbeads having, e.g., a specific weight in the range of 1 g/cm³ to 8 g/cm³, and electrically-insulating microbeads having, e.g., specific weights in the range of 0.6 g/cm³ to 1.5 g/cm³, whereby the liquid-phase resin and curing agent mixture 214 exhibits a specific weight in the range of 0.3 g/cm³ to 2 g/cm³. Of course, other types of “heavy” microparticles may be used as well.

In another embodiment of the invention, the microparticles 212 of the first mixture 210 have a lower (i.e., lighter) specific weight than the liquid-phase resin and curing agent mixture 214. In such an embodiment, the process 114 of centrifuging the first mixture 210 to extract a volume of liquid-phase resin and curing agent mixture 214 is accomplished by extracting the higher specific weight resin and curing agent mixture 214 through one or more outlet ports of a casting mold holding the first mixture 210, the one or more outlet ports, in one embodiment, positioned distally from the centrifuge spin axis. In this embodiment, the higher specific weight liquid-phase resin and curing agent mixture 214 will be accelerated away from the centrifuge spin axis and out via the one or more outlet ports. In this manner, a volume of the liquid-phase resin and curing agent mixture 214 is extracted from the first mixture 210, resulting in the liquid-phase matrix 220 within the casting mold. Specific embodiments of the “light” microparticles include the aforementioned hollow insulating microspheres having, e.g., a specific weight in the range of 0.1 g/cm³ to 1.0 g/cm³, whereby the liquid-phase resin and curing agent mixture 214 exhibits a specific weight in the range of 0.3 g/cm³ to 2 g/cm³. Of course, other types of low weight microparticles may be used as well.

Further particularly with regard to process 114, centrifuging may occur at different speeds depending upon the construction of the microparticles. For example, the centrifuge may be controlled to operate at lower speeds when hollow microspheres are used to prevent their breakage, whereas higher speeds may be used when solid or substantially non-deformable microbeads are used. Exemplary centrifuge speeds would be operable to produce acceleration due to gravity forces in the range of 2-200 g/forces, and perhaps more particularly between 2-70 g/forces for the hollow microspheres and 2-170 g/forces for the solid ceramic microbeads. In addition, different centrifuging speeds may be used during the course of the centrifuging process 114.

Process 116 in which the liquid-phase matrix 220 is cured may be accomplished through various operations. In one embodiment, the resin and curing agent mixture 214 is operable to cure at ambient conditions. In such an embodiment, sufficient time is allowed for the liquid-phase matrix 220 to cure, and the resulting molded structure removed from the casting mold. The molded structure may require additional machining to modify the shape of the molded structure as desired.

In another embodiment of process 116, the liquid-phase matrix 220 is cured by an elevated temperature. A specific embodiment of this process would be to remove the casting mold in which the liquid-phase matrix is placed from the centrifuge, and place the casting mold into an oven. The required curing temperature and time will vary depending upon the particular resin and curing agent mixture, and volume thereof, but typical values will generally be in the range of 50-180° C. applied for 10-120 mins.

As an alternative to oven curing the liquid-phase matrix 220, one or more heating elements may be placed around or within the casting mold to provide heat to the casting mold to cure the liquid-phase matrix in this manner. Further particularly, two or more heating elements may be placed in separate areas of the casting mold, each heating element activated at a different time and/or a different heating level to cure the liquid-phase matrix 220 in a particular sequence. In one exemplary embodiment, a curing profile is provided such that peripheral areas most distal to the intake port are cured first, and areas more proximate to the intake are cured subsequently. With such a curing profile, the intake of the casting mold remains free so as to supply additional resin/curing agent and microparticle mixture, thereby preventing the formation of voids within the cured structure, as well as to compensate the volume shrinkage. An exemplary embodiment of this process is further described below.

Additional operations may be used to those in 112-116 in FIG. 1. For example, the first mixture 212 may be agitated before, during and/or after the centrifuge process 114 to facilitate formation of the liquid-phase matrix 220.

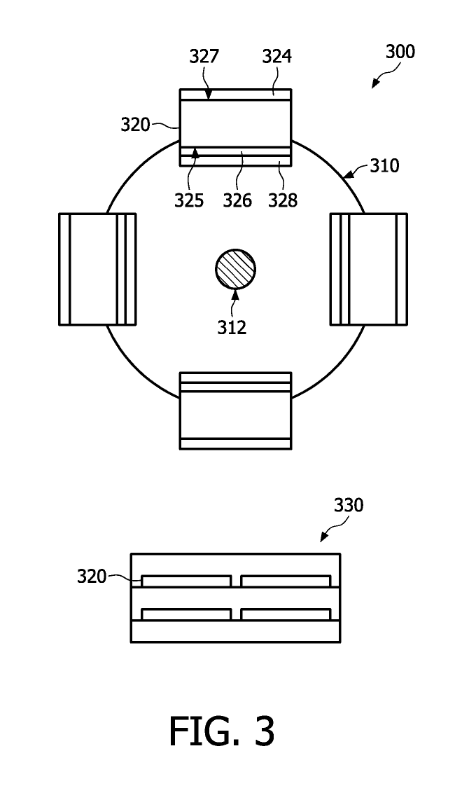

FIG. 3 illustrates a system for manufacturing a molded structure in accordance with one embodiment of the present invention. The system 300 includes a centrifuge 310 and one or more casting molds 320 mechanically coupled (directly or indirectly connected) to the centrifuge 310. The centrifuge is operable to spin around its spin axis 312, exemplary speeds operable to produce acceleration due to gravity forces in the range of 2-200 g/forces, and perhaps more particularly between 10-50 g/forces.

The casting mold 320 is removable secured to the centrifuge 310 (e.g., by screws, locking nut/bolt and the like) and is operable to contain a mixture of microparticles 212 and the resin/curing agent 214, initially in the form of a first mixture (210, FIG. 2A), and subsequent to centrifuging, in the form of a densely-packed liquid-phase matrix (220, FIG. 2C). In the illustrated embodiment in which the resin/curing agent mixture 214 has a higher specific weight than the microparticles (212, FIG. 2A-C), the casting mold 320 includes an outlet port 327 distally located from the spin axis 312, the outlet port 327 providing the channel through which the heavier specific weight resin/curing agent mixture is removed when the casting mold 320 is spun by the centrifuge. Further particularly, the casting mold 320 is adapted to retain a matrix of microparticles which are at least partially-coated with the resin/curing mixture 214 when the centrifuge spins the casting mold 320. The outlet port 327 operates as a barrier to the smallest desired microparticle, and may be formed as a screen, grating, mesh, a small gap, or similar barrier to the microparticles. In another embodiment of the invention, a plurality of outlet ports (2, 3, 5, 10, 50, 100, or more) may be implemented. Furthermore, the one or more outlet ports 327 may be deployed in some instances proximate to the spin axis, either alternatively or in addition to the distally located one or more outlet ports, as described above.

Further optionally, the system 300 includes one or more relief kidneys 324 coupled in communication with the casting mold 320 via the outlet port 327, the relief kidney(s) 327 operable to store a volume of liquid-phase mixture of resin/curing agent mixture 214 taken up from the casting mold. Also optionally, the system 300 includes one or more intake ports 325, and a supply reservoir 326 in communication with the casting mold 320 via the intake port(s) 325, the supply reservoir 326 operable to contain a volume of mixture 210 containing microparticles 212 and the resin/curing agent mixture for supply to the casting mold 320. Supplying an additional volume of the resin and curing agent mixture 214 during the centrifuging process may assist in expediting the formation of the liquid-phase matrix 220. Introduction of the microparticles 212 and resin/curing agent mixture 214 into the casting mold 320 may be accomplished by aspiration or injection, the latter being performed, e.g., by means of pump 328 and/or pressure reservoir coupled to the supply reservoir 326 to supply additional volume to the mold.

The liquid-phase matrix 220 formed within the casting mold 320 as a result of the centrifuging process is cured to form a solid-phase matrix of the mold structure. The curing process may be accomplished using a variety of techniques, for example under ambient conditions, pressure and temperature, or by elevating the pressure and/or temperature of the casting mold 320. In one embodiment, the casting molds 320 are detached from the centrifuge 310, and placed into an oven 330 to cure the liquid-phase matrix into the molded structure.

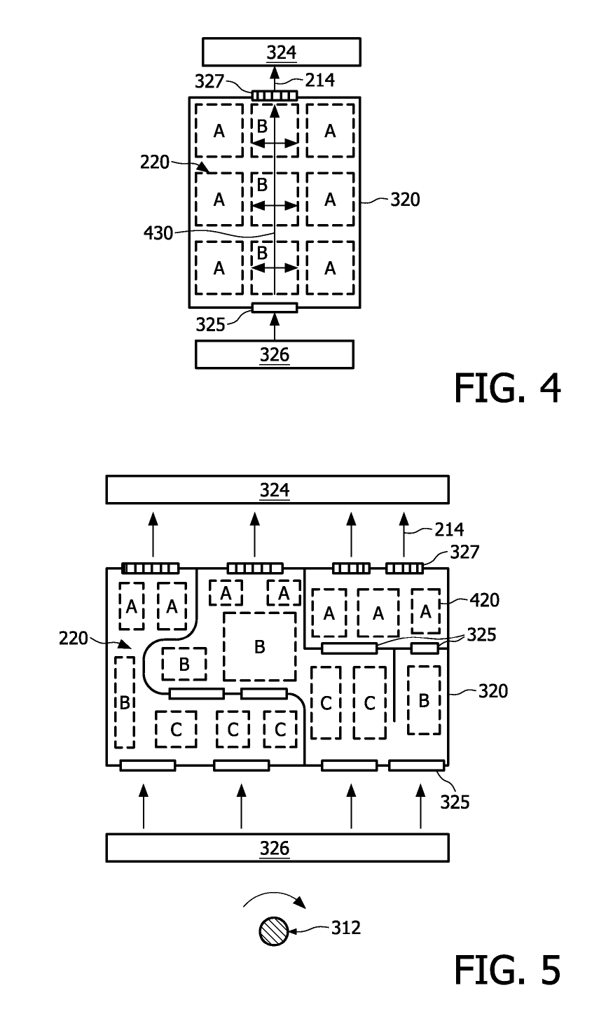

Further optionally, curing may be accomplished by means of two or more heating elements which are controlled to provide a particular heating profile. FIG. 4 illustrates an exemplary embodiment of a casting mold employing heating elements A and B to provide such a heating profile, with previously identified features retaining their reference numerals. The casting mold 320 (with top removed to show detail) includes heating elements A disposed on the outer peripheral surface of the casting mold positioned most distally from the intake port 325, and heating elements B disposed on the casting model surfaces located most proximate to the intake port 325. Heating element A is activated first to allow the peripheral areas of the casting mold to cure first. Heating element B is activated next, thereby allowing intake port 325 to remain unblocked until the end of the curing process. The area along the flow path 430 is cured last to enable supplying microparticles and resin/curing agent mixture therefrom, which prevents the formation of air gaps or voids in the cast structure, as well as to compensate for volume shrinkage. In a further embodiment, the heating profile includes activating heating elements A and B to provide different temperatures, e.g., heating pad A is provided power to heat at a higher temperature compared to heating element B (e.g., 10° C. less than heating element A). In this arrangement, heating elements B will cure slower to provide access to the peripheral areas of the casting mold.

Further optionally, a vibration apparatus (not shown) may be used to provide vibration forces to the casting mold (e.g., during centrifuging) to further facilitate the formation of the liquid-phase matrix 220 within the casting mold 320, such forces also optionally implemented during the centrifuging process 114, described above.

### EXEMPLARY APPLICATIONS

In an exemplary embodiment of the invention, a molded structure used for insulating components of an x-ray computed tomography (CT) generator is manufactured using the processes described herein. Hollow electrically-insulating microspheres are used as the microparticles 212 to provide a combination of light weight and a high insulating voltage characteristic for the molded insulating structure. Low weight is an important factor for the x-ray CT generator, as it travels at a high rate of speed to produce in the range of 40 g/forces. Accordingly, a reduction in the weight of the high voltage insulation provides significant advantages in reducing the stress level of the assembly. Similar advantages may be obtained for structures which are subjected to high speed and/or high gravitational forces, including structures used in the aircraft, spacecraft, or other airborne industries, automobile industries and the like.

FIG. 5 illustrates a casting mold for manufacturing a molded high voltage insulation structure in accordance with the invention, with previously identified feature retaining their reference numerals. The casting mold 320 contains a liquid-phase matrix 220 of microparticles immersed in a resin and curing agent mixture, the microparticles used being glass microspheres having a diameter in the range of 10-150 um, a wall thickness of less than 1 um, and a specific weight in the range from 0.1-1.0 g/cm³. The resin and curing agent mixture exhibits a specific weight in the range from 0.3-2.0 g/cm³. The casting mold 320 is an inverse image of the insulation structure which is to be formed, and includes intake ports 325 for receiving additional microspheres and resin/curing agent mixture 214 from the supply reservoir 326, and outlet ports 327 through which the higher specific weight resin and curing agent mixture 214 is extracted during centrifuging. The intake ports 325 may be disposed on the exterior and interior walls of the mold to permit circulation of the microspheres and resin/curing agent mixture therethrough. Outlet ports 327 include a 5 um barrier (e.g., a screen or mesh having 5 um gaps therein) operable to retain the smallest desired hollow microsphere within the casting mold 320. Supply reservoir 326 is operable to provide additional microspheres and additional resin/curing agent mixture 214, and relief kidney 324 is operable to take up the extracted resin and curing agent mixture 214 extracted from the casting mold 320 during centrifuging. Further exemplary, the interior walls may be coupled to one or more relief kidneys for taking up extracted resin/curing agent mixture during the centrifuging process.

Heating elements A and B are provided around the casting mold periphery (and optionally internally within the casting mold 320) to apply a predefined heating profile to the liquid-phase matrix. In one particular embodiment, heating elements A and B are heated in progression (heating elements A first, and B second) so as to cure the structure in areas most distally-located from the intake ports 325 first. The curing profile enables injection of microspheres and resin/curing agent mixture into the casting mold 320 during the curing process to avoid the formation of air gaps within the mold. In another embodiment, one or more of the heating elements may be activated during the centrifuging process.

The casting mold 320 is coupled to a centrifuge (310, FIG. 3) operable to rotate clockwise (or counter-clockwise) around a spin axis 312, the centrifuge in this embodiment is formed to in the general shape of a gantry of an x-ray scanning system, although other types of centrifuge structures can be used in further embodiments of the invention. The centrifuge is adapted to couple one or more of the casting molds, and to spin the casting molds at the required speed to produce acceleration due to gravity forces in the range of 2-200, and perhaps more particularly between 10-160.

Curing of the liquid-phase matrix is performed by detaching the casting mold 320 from the centrifuge and placing the mold 320 into an oven (330, FIG. 3) at 160° C. for 30 minutes. The resulting molded structure can then be used as a lightweight, high voltage insulating insert within an x-ray high voltage generator. Exemplary densities of such structure may be in the range of 0.60 g/cm³ or less, for example, 0.5 g/cm³, 0.45 g/cm³, 0.4 gm/cm³, 0.3 g/cm³, or lower densities depending upon the specific weight of the microparticles 212 and resin and curing agent mixture 214.

In a further embodiment of the invention, conductive/inductive microparticles in the form of ferromagnetic particles are used to form a densely-packed magnetic structure, a cross-section of which is that as shown in FIG. 2C. In a specific example, the ferromagnetic particles are metal (e.g., iron) powder having a specific weight (e.g., 5-20 g/cm³) which is higher (heavier) than the resin/curing agent mixture 214, which when cured forms the matrix. The resin/curing agent mixture 214 may be a mixture of CY231, HY925, DY044 (Huntsman Corp.) and S732 (Byk-Chemie) which forms a rigid matrix when cured, or it may be silicone/polyethylene/elastimer thermoplastic or other materials which when cured forms a flexible matrix. Further specifically, the ferromagnetic material is multi-grade, e.g., having a first grade of microparticles having a diameter less than 20 um, a second grade of microparticles in the range of 90-100 um, and a third grade of microparticles in the range of 300-400 um. Of course, other types of microparticles as well as grades (or even a single grade of microparticles) could be used in other embodiments of the present invention. The structure may be cast to form any particular structure in which a densely-formed magnetic field is needed.

It summary it may be seen as one aspect of the present invention that centrifugal forces are used to separate microparticles from the liquid-phase resin and curing agent mixture in which the microparticles are immersed, the microparticles retaining a surface coating of the resin and curing agent mixture, which, when cured, provides an solid-phase matrix of the microparticle to form the molded part. In this manner, an excess of resin and curing agent mixture in the construction of the molded structure is avoided. A particular embodiment of the invention is the manufacture of a high density, low weight solid-phase foam having a high breakdown voltage characteristic suitable as an insulating material.

As readily appreciated by those skilled in the art, the described processes may be implemented in hardware, software, firmware or a combination of these implementations as appropriate. In addition, some or all of the described processes may be implemented as computer readable instruction code resident on a computer readable medium (removable disk, volatile or non-volatile memory, embedded processors, etc.), the instruction code operable to program a computer of other such programmable device to carry out the intended functions.

It should be noted that the term “comprising” does not exclude other features, and the definite article “a” or “an” does not exclude a plurality, except when indicated. It is to be further noted that elements described in association with different embodiments may be combined. It is also noted that reference signs in the claims shall not be construed as limiting the scope of the claims. The term “coupling” is used to indicate either a direct connection between two features, or an indirection connection, via an intervening structure, between two features. Operations illustrated in flow charts are not limited to the particular sequence shown, and later numbered operations may be performed currently with, or in advance of earlier number operations in accordance with the invention.

The foregoing description has been presented for purposes of illustration and description. It is not intended to be exhaustive or to limit the invention to the precise form disclosed, and obviously many modifications and variations are possible in light of the disclosed teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined solely by the claims appended hereto.

1. A method for manufacturing a molded structure, comprising:
providing a first mixture comprising microparticles and a liquid-phase mixture of resin and curing agent (112);
centrifuging the first mixture to extract a volume of the liquid-phase resin and curing agent mixture from the first mixture, whereby a liquid-phase matrix of microparticles which are at least partially-coated with liquid-phase resin and curing agent is formed thereby (114); and
curing the liquid-phase matrix of at least partially coated microparticles to form a solid-phase matrix of microparticles, the solid-phase matrix of microparticles forming the molded structure (116).

2. The method of claim 1,
wherein providing a first mixture (112) comprises providing the first mixture into a casting mold coupled to a centrifuge, the centrifuge having a spin axis around which the casting mold is operable to spin, the casting mold including one or more outlet ports;
wherein the microparticles comprise conductive/inductive microbeads, whereby the at least partially-coated conductive/inductive microbeads have a higher specific weight than the specific weight of the liquid-phase resin and curing agent mixture; and
wherein centrifuging the first mixture (114) comprises evacuating, via the one or more outlet ports of the casting mold, a volume of the liquid-phase resin and curing agent mixture.

3. The method of claim 1,
wherein providing a first mixture (112) comprises providing the first mixture into a casting mold coupled to a centrifuge, the centrifuge having a spin axis around which the casting mold is operable to spin, the casting mold including one or more outlet ports;
wherein the microparticles comprise insulating microspheres, whereby the at least partially-coated insulating microspheres have a lower specific weight than the specific weight of the liquid-phase resin and curing agent mixture; and
wherein centrifuging the first mixture (114) comprises evacuating, via the one or more outlet ports of the casting mold, a volume of the liquid-phase resin and curing agent mixture.

4. The method of claim 2, wherein the one or more
outlet ports are located distal to the spin axis, or proximate to the centrifuge spin axis, or at least one outlet port located proximate to the centrifuge spin axis, and at least one outlet port located distal to the centrifuge spin axis.

5. The method of claim 1, wherein the liquid phase mixture of resin and curing agent provided with the first mixture forms a rigid structure upon curing.

6. The method of claim 1, wherein the liquid phase mixture of resin and curing agent provided with the first mixture forms a flexible structure upon curing.

7. The method of claim 1, further comprising agitating the first mixture of the microparticles and the liquid-phase resin and curing agent mixture.

8. The method of claim 1, wherein the casting mold further includes one or more heating elements disposed around at least a portion of the periphery of the casting mold, the method further comprising applying a predetermined heating profile to the casting mold via the one or more heating elements.

9. A system for manufacturing a molded structure, the system comprising:
a centrifuge (310) operable to spin around a spin axis (312); and
a casting mold (320) coupled to the centrifuge (310) and operable to contain a first mixture comprising microparticles and a liquid-phase mixture of resin and curing agent, the casting mold (320) comprising one or more outlet ports (327) through which a volume of the liquid-phase resin and curing agent is evacuated when the casting mold (320) is spun, whereby the casting mold (320) is operable to retain a liquid-phase matrix of microparticles which are at least partially-coated with the liquid-phase resin and curing agent mixture when the centrifuge (310) is spun.

10. The system of claim 9, wherein the one or more outlet ports (427) are formed on the casting mold (320) in positions which are proximate to the spin axis (312) of the centrifuge (310), or distal to the spin axis (312) of the centrifuge (310), or at least one outlet port (427) located in a position which is proximate to the spin axis (312), and at least one outlet port (427) is located in a position which is distal to the spin axis (312).

11. The system of claim 9, wherein the curing device (330) comprises one or more heating elements (420) disposed around at least a portion of the periphery of the casting mold (320), the collective plurality of heating elements (420) operable to apply a predefined heating profile to the casting mold (320).

12. A high voltage insulating foam operable for use with a high voltage x-ray tube generator manufactured according to the method of claim 1.
